(19) United States
(12) Patent Application Publication
(10) Pub. No.: US 2012/0273337 A1
(43) Pub. Date: Nov. 1, 2012

(54) WATER PURIFICATION SYSTEMS AND METHODS

(76) Inventor: Mike Wofsey, Golden, CO (US)

(21) Appl. No.: 13/499,883

(22) PCT Filed: Oct. 4, 2010
(86) PCT No.: PCT/US10/51351

§ 371 Date: Jun. 25, 2012

Related U.S. Application Data
(60) Provisional application No. 61/278,058, filed on Oct. 2, 2009.

(51) Int. Cl. C02F 1/14; B01D 3/02

(52) U.S. Cl. 203/10; 202/185.3; 202/184

(57) ABSTRACT

An exemplary water purification system has a base and a cover that is coupled (e.g., heat sealed) to the base to form a chamber. Raw water, such as seawater or polluted water, is inserted into the base. The raw water evaporates and condenses on an inner surface of the cover, which is inclined to cause the condensed water to flow to a collection channel so that potable water may be drawn from such channel. The base and cover are formed of a lightweight, flexible material to allow the system to be collapsed for easy transport. In addition, the base and cover are supported by a collapsible frame. Accordingly, the system can be easily packaged and shipped at a relatively low cost.

### CROSS REFERENCE TO RELATED APPLICATION

This is a national stage application of International Application No. PCT/US10/51351, entitled “Water Purification Systems and Methods,” and filed Oct. 4, 2010, which is incorporated herein by reference and claims priority to U.S. Provisional Patent Application No. 61/278,058, entitled “Water Purification Systems and Methods” and filed on Oct. 2, 2009, which is incorporated herein by reference.

### RELATED ART

Solar distillation has been used to provide clean drinking water and can be particularly useful in third world countries or rural areas where potable water is not always readily available. In addition, there is typically a need for potable water in the wake of natural disasters, such as hurricanes and earthquakes, which can disrupt drinking water channels.

However, the evaporation rate of water is generally slow, and providing large volumes of potable water via solar distillation can be problematic. Previous solar distillation systems capable of producing significant amounts of potable water have typically been bulky, often immobile, and expensive to manufacture.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 illustrates an exemplary embodiment of a water purification system.

FIG. 2 illustrates a back view of the water purification system depicted by FIG. 1.

FIG. 3 illustrates a cross-sectional view of the water purification system depicted by FIG. 1.

FIG. 4 illustrates a cross-sectional view of a cover and a gutter of the water purification system depicted by FIG. 1.

FIG. 5 illustrates a portion of the gutter depicted by FIG. 4.

FIG. 6 illustrates a top view of the water purification system depicted by FIG. 1.

FIG. 7 illustrates a cross-sectional view of the water purification system depicted by FIG. 1.

FIG. 8 illustrates exemplary material that may be used to form a base of the water purification system depicted by FIG. 1.

FIG. 9 illustrates exemplary material that may be used to form a cover of the water purification system depicted by FIG. 1.

FIG. 10 illustrates an exemplary absorption pad that may be used with the water purification system depicted by FIG. 1.

FIG. 11 illustrates a side view of the absorption pad depicted by FIG. 10.

FIG. 12 illustrates a side view of the water purification system depicted by FIG. 1 when the absorption pad depicted by FIG. 11 is positioned in an evaporation chamber of the water purification system.

### DETAILED DESCRIPTION

The present disclosure generally pertains to water purification systems and methods. In one exemplary embodiment, solar distillation is used to convert raw water, such as seawater or polluted water, into potable water suitable for drinking and other usages. The water purification system is lightweight and mobile. Further, to facilitate transportation and positioning of the system, the system is collapsible like a tent. In one exemplary embodiment, the system can be transported in a small package to a desired location and erected into a much larger structure on the order of several feet in length and width. By increasing the surface area of the system, the system is capable of purifying larger quantities of water in a given amount of time. Such a system is particularly useful for shipping to third world countries where the costs of shipping can be a relatively important sales consideration or to areas of a natural disaster where established channels of potable water may be temporarily disrupted. Also, individuals (e.g., campers) interested in a lightweight, portable system capable of delivering a significant amount of potable water may be particularly interested in the water purification systems described herein.

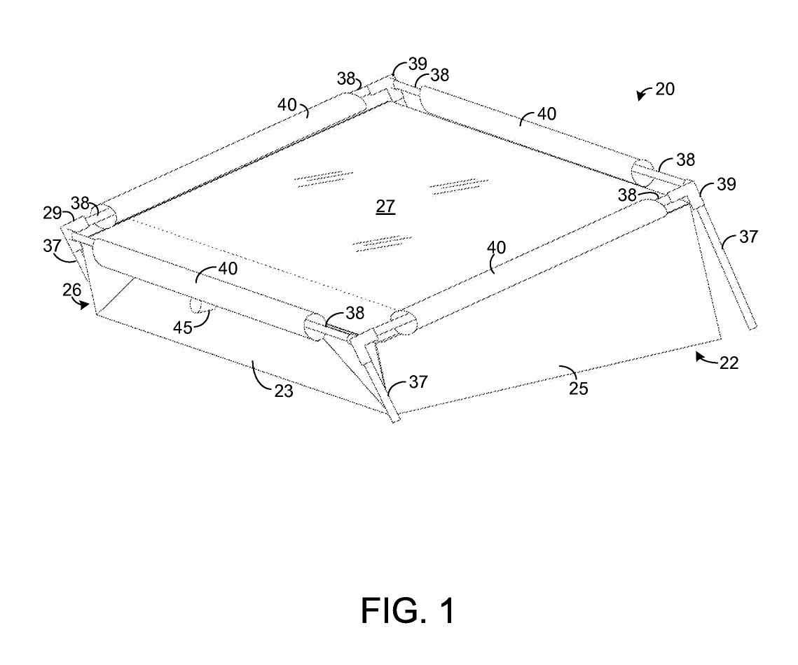

FIG. 1 depicts an exemplary water purification system 20. In one exemplary embodiment, the system 20 has a width of about 2 feet, a height of about 1½ feet, and a length of about 4 feet, but other dimensions are possible in other embodiments. The system 20 has a base 22 that forms a raw water reservoir for holding raw water, such as polluted water or seawater. In one exemplary embodiment, the base 22 is composed of fiber-reinforced 6-mil polyethylene and is black in color to increase the amount of sunlight absorbed by the base 22 and, therefore, the temperature within the system 20. However, other types of materials and other colors are possible in other embodiments.

A cover 27 is coupled to the base 22. The cover 27 is composed of a transparent material, such as clear 6-mil polyethylene with anti-condensate coating, to allow light to pass through the cover 27 and heat the interior of the system 20, similar to a greenhouse. That is, heat generated from sunlight passing through the cover 27 is trapped within the system 20 causing the temperature in the system 20 to rise, much higher than the atmospheric temperature outside of the system 20, and the raw water in the base 22 evaporates. The anti-condensate coating on the inside surface of the cover 27 resists the formation of droplets and causes condensed water to sheet rather than collect as droplets thereby allowing for a clearer optical path of sunlight into the system 20.

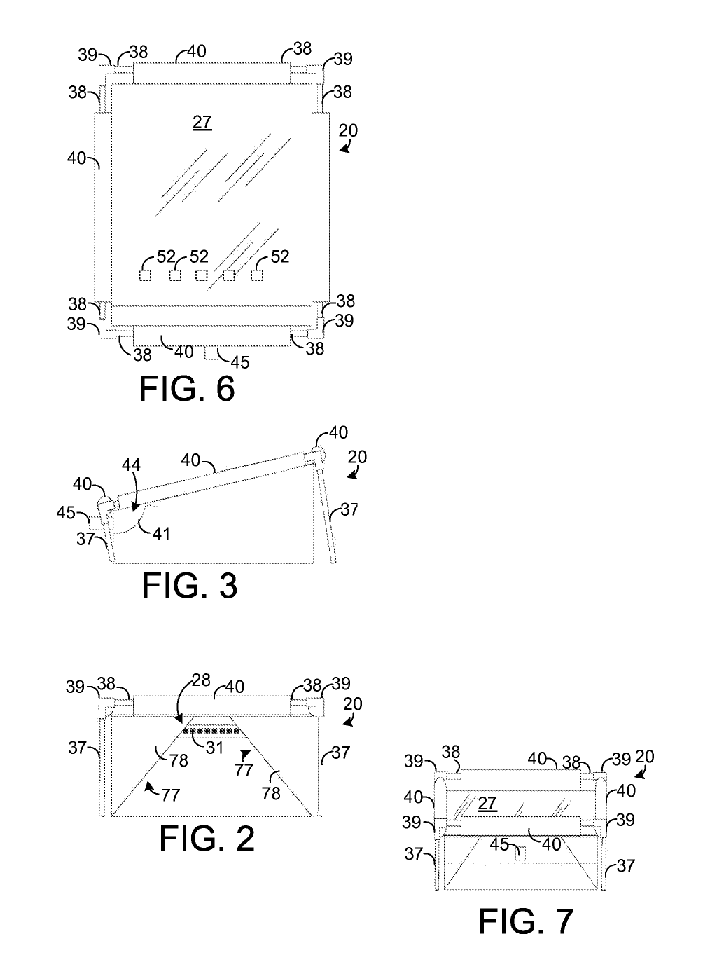

The cover 27 and the base 22 form a sealed evaporation chamber 21 (FIG. 3) in which the raw water resides and evaporates. In one exemplary embodiment, the cover 27 is heat sealed to the base 22, but other techniques of coupling the cover 27 to the base 22 or otherwise forming the system 20 are possible. The base 22 has a front 23, a back 24 (FIG. 2), and a pair of sides 25 and 26.

As shown by FIG. 2, the base 22 has a slit 28 that is selectively opened and closed. In this regard, a zipper 31 or other closing apparatus can be unzipped to open the slit 28 and allow raw water to be poured or otherwise fed into the base 22. The zipper 31 can then be zipped to close the slit 28, as is shown in FIG. 2, thereby sealing the interior chamber of the system 20 so that the humidity and temperature within the system 20 is increased. In other embodiments, the slit 28 may be at other locations, such as in the cover 27. Further, devices other than a zipper, such as buttons or Velcro, may be used to close the slit.

A collapsible frame 32 provides support to the base 22 and holds the base 22 in the shape shown. The frame 32 comprises various interconnected support elements 37 and 38, as shown. In one exemplary embodiment, the support elements 37 and 38 comprise polyvinyl chloride (PVC) piping of a hollow and cylindrical shape, but other types (e.g., poles) and shapes of support elements 37 and 38 can be used in other embodiments. In the exemplary embodiment shown by FIG. 1, vertical support elements 37 are positioned at each corner of the base 22, and each vertical support element 37 is coupled to a pair of horizontal support elements 38 via respective sleeve 39, which is also composed of PVC piping in one embodiment. Each sleeve 39 has an inner diameter slightly larger than the outer diameters of the support element 37 and 38 that are inserted into the sleeve 39. Thus, the support elements 37 and 38 snugly fit into the sleeve 39 such that frictional forces hold the support elements 37 and 38 in the sleeve 39. Such frictional forces can be overcome by pulling the support elements 37 and 38 by hand out of the sleeve 39 when the system 20 is being collapsed for transport or storage.

As shown by FIG. 1, sleeves 40 are coupled to the base 22, and each of the horizontal support elements 38 passes through a respective one of the sleeves 40. Thus, the base 22 is coupled to the horizontal support elements 38 through the sleeves 40 so that the top of the base 22 is held in the position shown by the frame 32.

As shown by FIG. 3, a gutter 41 runs along the front 23 of the base 22 across the entire length of the front 23 from one base corner to the next thereby forming a channel 44. Evaporated raw water from the base 22 condenses on the inner surface of the cover 27. Further, the vertical support elements 37 at the back 24 of the base 22 are taller and, therefore, hold the end of the cover 27 closest to the back 24 higher than the end of the cover 27 closest to the front 23. Thus, the cover 27 is positioned at an incline, and the condensed water, which is free of pollutants and salt, is pulled by gravity to the channel 44. Accordingly, the system 20 converts raw water in the base 22 to potable water in the channel 44 from where the potable water can be collected. In this regard, an outlet 45, such as a tube passing from the channel 44 to the exterior of the system 20 through the front 23 of the base 22 or otherwise, may be used to drain potable water from the channel 44.

Note that the frame 32 holds the respective positions of the base 22 and cover 27 such that the cover 27 is pulled and remains taut. Such a feature helps condensed water on the interior of the cover 27 to flow down to the channel 44 so that the incline of the cover 27 does not need to be as great to achieve the same flow rate relative to an embodiment in which the cover 27 is not pulled taut.

In one exemplary embodiment, the gutter 41 is formed by attaching the gutter 41 to the inner surface of the cover 27. In one exemplary embodiment, the gutter 41 is heat sealed or otherwise coupled to the cover 27 at various points along the length of the gutter 41. As an example, the coupling points may be separated by about 2 or 3 inches to allow water flowing along the inner surface of the cover 27 to pass between the coupling points and into the channel 44.

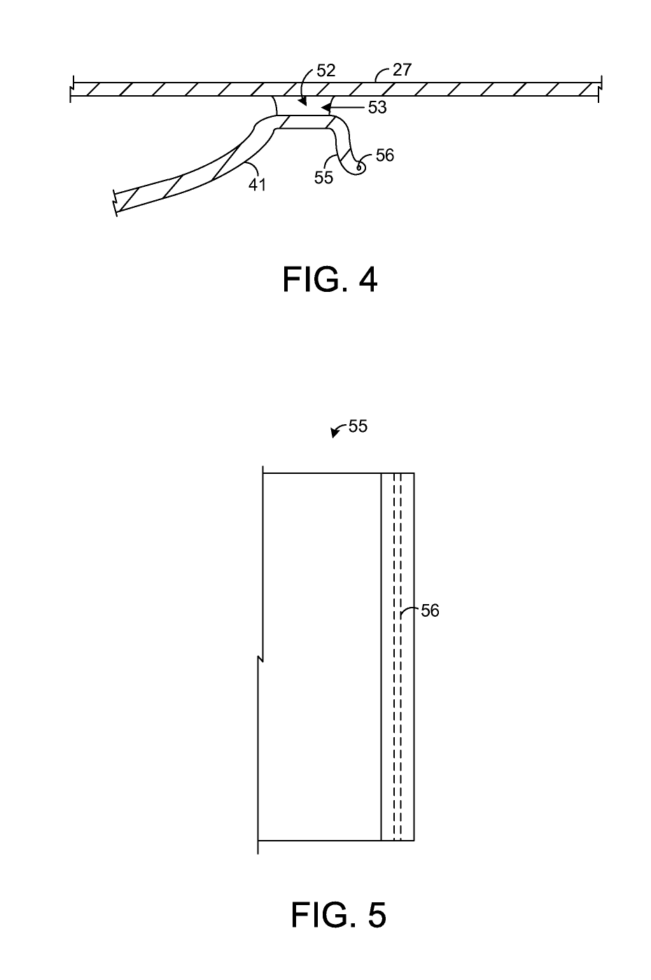

In this regard, refer to FIG. 4, which depicts a close-up of the gutter and cover 27 at a coupling point 52. As can be seen via FIGS. 4-6, a channel 53 is formed between consecutive coupling points 52, and condensed water on the inner surface of the cover 27 flows through the channel 53 between the coupling points 52 to the channel 44.

As also shown by FIG. 4, a portion of the gutter 41 extends past the coupling points 52 forming a flap 55. The end of the flap 55 forms a pocket in which a weight 56 resides. As an example, in one embodiment, the weight 56 comprises a cord that runs along the length of the gutter 41, as shown by FIG. 5, and is composed of a relatively heavy material such as lead, iron, or other metal. Gravity from the weight 56 pulls down on the gutter 41 to help keep the portions of the gutter 41 between the coupling points 52 separated from the cover 27 thereby preventing the channel 53 from being clogged. If the channel 53 is clogged, then condensed water could be undesirably prevented from reaching the channel 44.

There are various techniques that can be used to form the system 20. Exemplary techniques for forming the system 20 will be further described below.

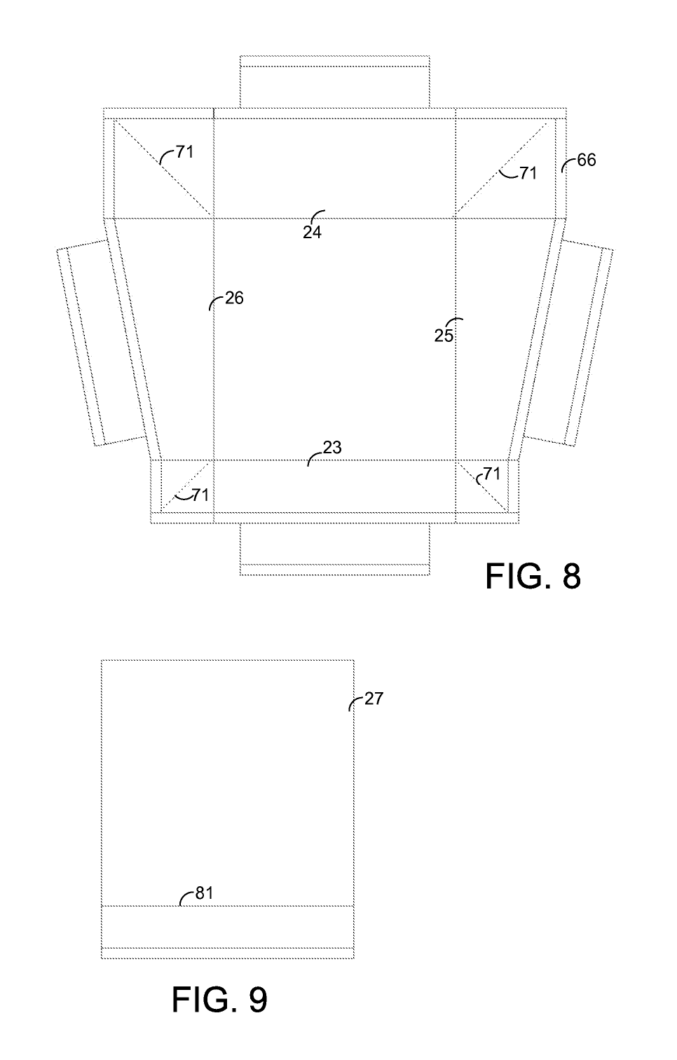

FIG. 8 shows a flat material that can be used to form the base 22. In this regard, the material can be folded along the indicated lines and then the top edge 66 of the base 22 can be folded and heat sealed to keep the folded shape of the base 22. The top edge 66 is shown in FIG. 8 for illustrative purposes but would actually be progressively formed as the material is being folded along the indicated lines. In this regard, as one portion of the base 22 is folded, the top edge 66 of such portion can be heat sealed to keep the folded shape while the remainder of the base 22 is folded and heated sealed in such progressive manner.

Note that each of the fold lines 71 at the corners creates an edge 77 (FIG. 2) that can be heat sealed to a respective one of the sides of the base 22, such as front 23, back 24, or sides 25 and 26. Such action creates a triangular flap 78 that is heat sealed to the rest of the base 22 along the edge 77, as shown in FIGS. 2 and 7.

FIG. 9 shows a flat material that can be used to form the cover 27 and gutter 41. In this regard, the material can be folded along the fold line 81 to form the gutter 41, which can then be heat sealed at coupling points 52 along the edge that is formed by folding along the line 81. The perimeter of the cover 27 after formation of the gutter 41 can then be heat sealed to the top edge 66 (FIG. 8) of the base 22.

Once the system 20 is formed by folding and heat sealing material as described above, the base 22 and cover 27, which are now joined together, can be folded or rolled up and inserted into a package for shipment. The support elements 37 and 38, as well as the sleeves 39, can also be inserted into such packaging. Once shipped, the recipient can easily assemble the packed materials to form the system 20 shown by FIG. 1.

Once the system 20 is erected, raw water is input to and held by the base 22. As an example, the zipper 31 may be unzipped to allow raw water to be inserted through the slit 28 in the base 22. Such raw water may be dumped from a bucket or otherwise. If desired, a user may insert a tube (not shown) through the slit 28 or other location and pump or otherwise feed raw water into the base 22 through the tube.

Once inserted into the base 22, the raw water evaporates and condenses on the inner surface of the cover 27. The condensed water is pulled by gravity such that it runs down the inner surface of the cover 27 to the channel 44. The outlet 45 may then be used to extract potable water from the channel 44 as may be desired.

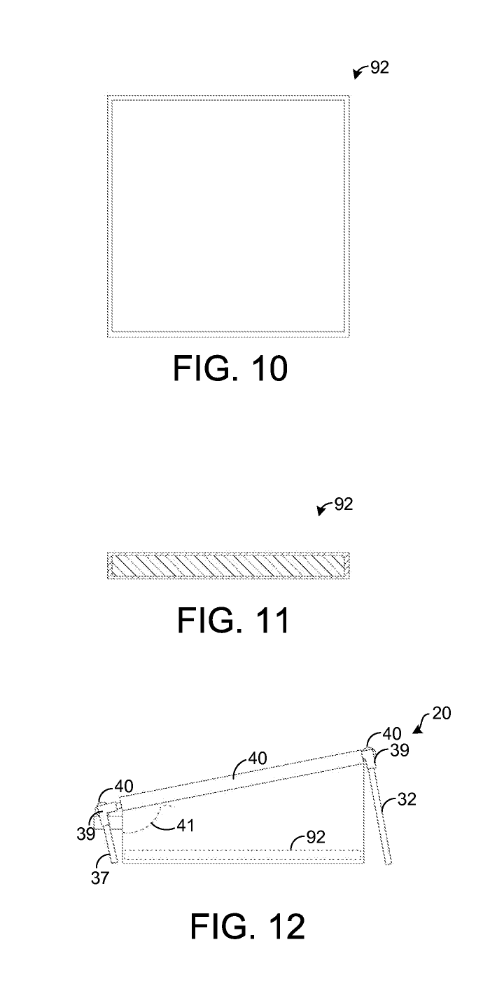

FIGS. 10 and 11 depict an absorption pad 92, which may be inserted into the evaporation chamber 21 and reside on the floor of the base 22, as shown by FIG. 12. The absorption pad 92 is composed of a material that absorbs the raw water in the base 22 thereby increasing the weight of the pad 92. Such weight helps to stabilize the system 20. In this regard, the weight of the raw water in the base 22 tends to hold down the system 20 helping to prevent the system 20 from tipping. However, slight movements of the system 20 or components of the system 20 can cause the raw water to move or slosh around potentially jeopardizing the stability of the system 20. Unlike the water in the base 22, the pad 92 should not generally move or slosh around helping to enhance the system's stability. However, use of such a pad 92 is optional.

The exemplary embodiments described herein can be manufactured at a relatively low cost yet provide good water purification performance. Further, the water purification systems described herein can be easily shipped at a relatively low cost. It would be apparent to one of ordinary skill in the art upon reading this disclosure that various modifications to the described systems are possible.

Now, therefore, the following is claimed:

1. A water purification system, comprising:
a base composed of flexible material and forming a reservoir for holding raw water;
a gutter forming a channel;
a cover composed of flexible material and coupled to the base, the cover positioned at an incline such that raw water evaporated from the reservoir condenses on an inner surface and is pulled by gravity to the channel; and
a collapsible frame for supporting the base and cover,
wherein the gutter is positioned within an evaporation chamber formed by the base and the cover.

2. The system of claim 1, wherein the frame comprises a plurality of support elements and a sleeve, wherein each of the support elements is inserted into the sleeve.

3. The system of claim 1, wherein the frame comprises:
a first sleeve;
a second sleeve;
a first support element inserted into the first sleeve;
a second support element inserted into the second sleeve; and
a third support element inserted into the first and second sleeves.

4. The system of claim 3, further comprising a third sleeve coupled to the base, wherein the third support element passes through the third sleeve.

5. The system of claim 3, wherein each of the support elements comprises a pole.

6. The system of claim 3, wherein each of the support elements comprises a polyvinyl chloride (PVC) pipe.

7. The system of claim 1, wherein the cover is transparent.

8. The system of claim 1, further comprising an absorbing pad for absorbing the raw water, wherein the absorption pad is positioned in the reservoir.

9. The system of claim 1, wherein the gutter is attached to an inner surface of the cover at a plurality of points.

10. The system of claim 9, wherein an end of the gutter is coupled to a weight.

11. A water purification method, comprising:
coupling a base to a cover of a water purification system, the base composed of a flexible material and the cover composed of a flexible material, the base and the cover forming an evaporation chamber;
inserting raw water into a reservoir formed by the base such that the raw water evaporates and condenses on an inner surface of the cover within the evaporation chamber;
positioning the cover at an incline such that gravity pulls the condensed water along the inner surface to a channel formed by a gutter that is within the evaporation chamber; and
coupling the base to a collapsible frame.

12. The method of claim 11, further comprising:
inserting a first support element of the frame into a first sleeve;
inserting a second support element of the frame into a second sleeve; and
inserting a third support element into the first and second sleeves.

13. The method of claim 12, further comprising inserting the third support element through a third sleeve that is coupled to the base.

14. The method of claim 11, wherein the cover is transparent.

15. The method of claim 11, wherein the gutter is attached to an inner surface of the cover at a plurality of points.
